(19) United States
(12) Patent Application Publication
(10) Pub. No.: US 2009/0106309 A1
(43) Pub. Date: Apr. 23, 2009

(54) Performing an Operation on an XML Database

(76) Inventors: Vikram Shinde, Pune (IN); Rupesh Bendale, Pune (IN); Bendale Gopal Puna, Korpavali (IN)

Correspondence Address: MEYERTONS, HOOD, KIVLIN, KOWERT & GOETZEL, P.C., P.O. BOX 398, AUSTIN, TX, 78767-0398, US

(21) Appl. No.: 12/035,113

(22) Filed: Feb. 21, 2008

(30) Foreign Application Priority Data
Oct. 22, 2007 (IN) 1436/KOL/2007

(51) Int. Cl. G06F 17/30

(52) U.S. Cl. 707/103 Y; 707/E17.055

(57) ABSTRACT

Performing an operation on an XML database. The method may include exchanging at least one DataObject between a client application and a Service DataObject (SDO) handler and transforming the DataObject into an XQuery operation for accessing XML documents of the XML database. The method may further include transforming an XML document obtained in response from the XML database to the XQuery into a DataObject. If the client application is Java based, the SDO handler may provide an interface between DataObjects defined in Java and XML documents retrieved by using XQuery expressions. The SDO handler may be part of a XQuery API for Java.

### PRIORITY CLAIM

This application claims benefit of priority of Indian application no. 1436/KOL/2007 titled “Method for Performing an Operation on an XML Database”, filed Oct. 22, 2007, and whose inventors are Vikram Shinde and Rupesh Bendale.

### INCORPORATED BY REFERENCE

Indian application no. 1436/KOL/2007 titled “Method for Performing an Operation on an XML Database”, filed Oct. 22, 2007, and whose inventors are Vikram Shinde and Rupesh Bendale, is hereby incorporated by reference in its entirety as though fully and completely set forth herein.

### TECHNICAL FIELD

The present invention relates to a method for performing an operation on an XML database and to a computer program and a database adapted to perform such a method.

### DESCRIPTION OF THE RELATED ART

XML databases are among the most important technical tools of modern information societies. The high degree of flexibility of such a database allows for storage and to retrieval of data in a highly efficient manner. XML databases are typically accessed using the query language XQuery. XQuery provides the means to extract and manipulate data from XML documents or any data source that can be viewed as XML, such as relational databases.

For many applications, tools and/or frameworks, it is desirable to access an XML database using standard programming languages such as Java or C++. To this end, binding technologies have been developed such as Java Architecture for XML Binding (JAXB), which allows Java developers to map Java classes to XML representations, thereby providing static interfaces between Java and XML, e.g., defined a development time.

However, using the known binding technologies for the access of an XML database is difficult and time consuming for a developer. Further, there are some applications, tools or frameworks, which require dynamic access to the XML database, which cannot be provided by the static interfaces of the prior art. Finally, the XML documents retrieved from the XML database using known APIs cannot typically be independently managed if the connection to the data source namely the XML database is lost. Accordingly, improvements in access to XML databases for applications, tools or frameworks are desired.

### SUMMARY OF THE INVENTION

Various embodiments are presented of a method for performing an operation on an XML database. The method may include exchanging at least one DataObject between a client application and a Service DataObject (SDO) handler. The method may further include transforming the DataObject into an XQuery operation for accessing XML documents of the XML database and transforming an XML document obtained in response from the XML database to the XQuery into a DataObject.

If the client application is Java based, the SDO handler may provide an interface between DataObjects defined in Java and XML documents retrieved by executing XQuery expressions. The SDO handler may be part of an XQuery API for Java.

Using the SDO handler, client applications may not need to care about XML parsing; instead, they can deal with simple Java interfaces having setter, getter methods. SDOs may be standardized according to the Java Specification Request 235 and may provide a uniform data access layer for heterogeneous data sources. Involving SDOs in the exchange of data between an application and an XML database can provide both a static and a dynamic way to manage the data retrieved from the database. In cases where metadata are known at development time of the application, the use of SDO may support, in a particularly easy manner, code-generating interfaces for DataObjects. The interface may, for example, be provided based on a schema definition of the XML documents stored in the XML database, wherein the schema definition may be provided by a registry.

Alternatively, or in addition to the static interface, the SDO handler may provide a dynamic interface, which defines at runtime the type of DataObjects handled by the SDO handler. As a result, schemata can be generated to documents which do not have a compatible schema.

In one embodiment, the operation may be at least one of the group comprising Create, Read, Update and Delete operations on the XML data in the XML database. The DataObject exchanged between the client application and the SDO handler may include a collection of tree-structured data, e.g., in particular a data graph. The SDO's Change Summary feature may enable access to change history information for a data graph. Further, an XPath based navigation through data graph is made possible.

According to another aspect, a Database management system (DBMS) for an XML database may be adapted to perform any of the above described methods. Finally, a computer program (e.g., computer accessible program instructions stored on a memory medium) may be adapted or executable to perform any of the described methods.

### SHORT DESCRIPTION OF THE DRAWINGS

In the following detailed description presently preferred embodiments of the invention are further described with reference to the following figures:

FIG. 1: A schematic representation of one embodiment for performing an operation on a XML database;

FIG. 2: A schematic representation of a preliminary step of generating a Java interface with a SDO generator, according to one embodiment;

FIG. 3: An exemplary implementation of a static interface provided by a SDO handler, according to one embodiment; and

FIG. 4: An exemplary implementation of a dynamic interface provided by a SDO handler, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

Various embodiments are presented of a method for performing an operation on an XML database. It will be understood that the functionality described below can be implemented in a number of alternative ways, for example for managing a single XML database server or a distributed arrangement of one or more XML databases. Further, while reference is made in the following to Java, the present invention can also be used with a variety of other programming languages such as C++ and others.

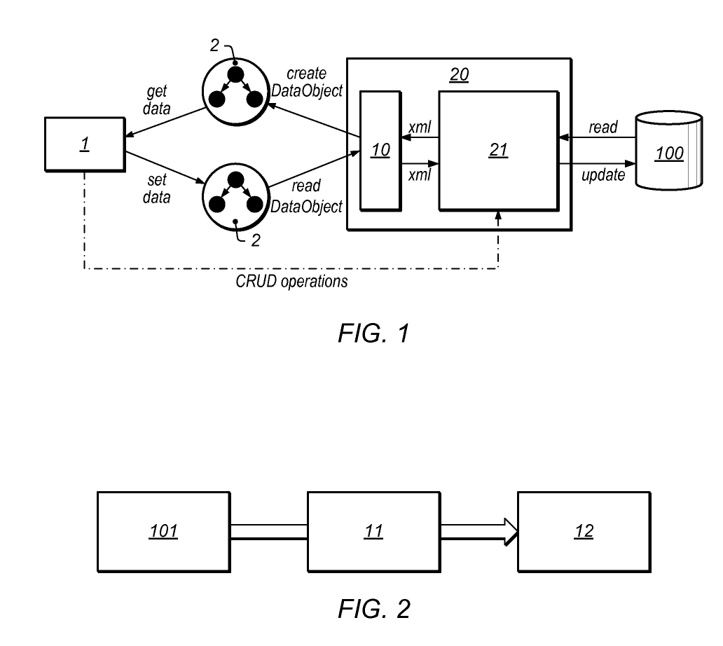

### FIG. 1

FIG. 1 presents a schematic view of the flow of operation between a client application 1 and an XML database 100. One example of the XML database 100 is available under the name “Tamino” from applicant. The connection between the client application 1 and the XML database 100 may be persistent or only temporary, e.g., if the XML database 100 is part of a service oriented architecture (SOA). Information about requests serviced by the XML database 100 may be provided in a registry (not shown in the figures), which may contain metadata concerning the content of the XML database such as schema information. One example of such a registry is available from applicant under the name “Centrasite”.

The schematic representation in FIG. 1 illustrates two operations, namely a “get data” operation, wherein the client application 1 requests data from the XML database 100, and a “set data” operation, wherein the client application transmits data to the XML database 100, possibly a modified version of the data just received. Generally, there may be a variety of operations performed on the XML data base, wherein the most relevant ones are so-called CRUD operation causing the creation, the reading, the update and/or the deletion of data in the XML data base 100.

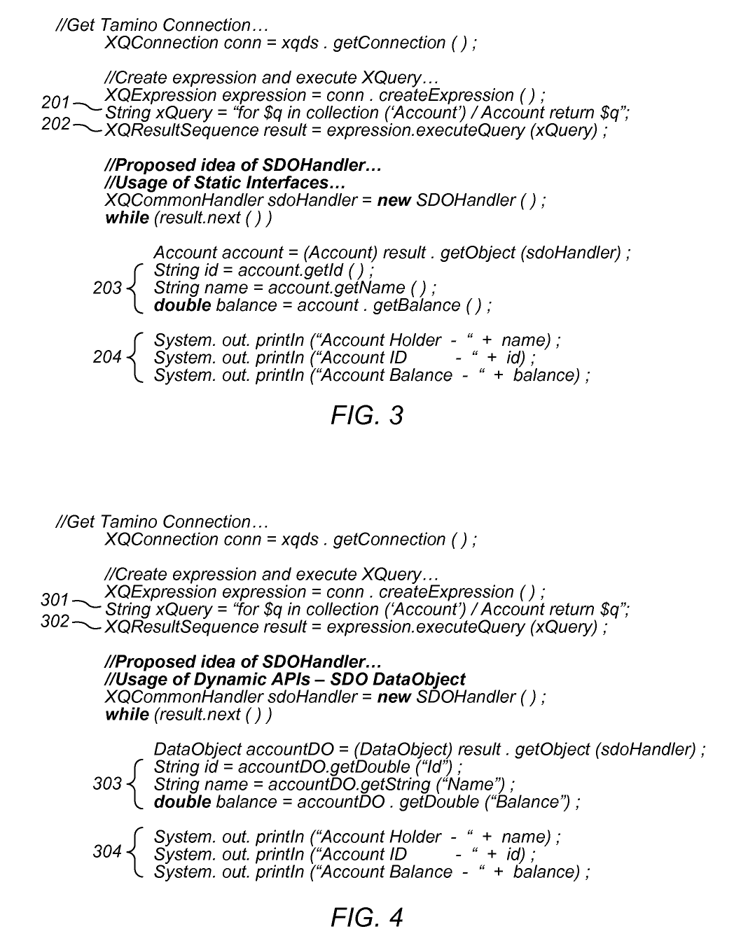

As can be seen from FIG. 1, the client application 1 may exchange DataObjects 2 with a SDO handler 10, examples of which are described further below with reference to FIGS. 3 and 4. The term “Service Data Object” (SDO) refers to a data programming architecture and an API. It may simplify data programming by unifying data programming across data source types, provide support for common application patterns and enable applications, tools, and frameworks to more easily perform operations such as query, view, and bind.

The DataObjects 2 may be either static or dynamic, e.g., their types may be either pre-defined at development time or dynamically determined during runtime. One example of the exchanged DataObjects 2 is a data graph 2, as schematically shown in FIG. 1. A data graph 2 is a collection of tree-structured or graph-structured data. Having received the data graph 2, the client application 1 may change or mutate the data graph 2 and then apply changes thereof back to the data source, e.g., the XML database 100. Most commonly, the update may be performed with optimistic concurrency semantics, which means that if any of the underlying data was changed before the client application 1 applies the changes, the update may be rejected and the client application 1 may take corrective action.

In the embodiment of FIG. 1, the client application 1 may use an XQuery API 20 for Java (XQJ) in accordance with the Java Specification Request 225 as a data mediator service 21 to access documents in the XML database 100. XML documents which are retrieved from the XML database may be loaded by the SDO handler 10 as dynamic SDO DataObject instance or an instance of a class implementing one or more static Java interfaces. In other words, the SDO handler 10 converts XML data into Java objects and vice versa. As a result, the XML documents can outlive Java Objects even if the connection to the data source, e.g., the XML database 100, is lost.

The Java interfaces are generated as schematically shown in FIG. 2. An SDO Interface generator 11 may use metadata on the documents in the XML database 100 as input, such as a schema definition 101, and generate one or more static Java interfaces 12, which can then be used by the client application 1 (or any other application, not shown in FIG. 1). Therefore, the URL or file path of the required metadata inside the database, e.g., a schema definition, may need to be specified to the SDO interface generator 11. The generated code may bestored at the provided directory path.

An example of the call of the SDO interface generator could be in agreement with the following definitions:
C:\>set CLASSPATH=%CLASSPATH%;c:\sdo\lib\sdo.jar
C:\>java com.softwareag.sdo.codegen.XSD2javaGenerator-?
Usage: XSD2JavaGenerator <options>
   where the possible options include

| | |
|---|---|
| -d OR -dir | Specify where to put generated code. |
| -c OR -clrdir | Clean the directory before generation |
| -v OR -verbose | Enable verbose. |
| -config | Provide all configurations as XML file. |
| -s OR -schema | Specify schema file path or URL |
| -l OR -logdir | Specify the log directory location. |
| -? OR -help | Provides Usage help. |

A practical example of the related call is shown below:
C:\>java com.softwareag.sdo.codegen.XSD2JavaGenerator-s C:\schemas\ipo.xsd-d
C:\generatedSources

FIG. 3 presents an example of a static interface of the SDO handler 10 and its use. It illustrates how documents retrieved from the XML database 100 can be handled by the SDO handler 10. As can be seen, an exemplary XQuery expression “for $q in collection (‘Account’)/Account return $q” may be assigned, in 201, to a variable of type string. Further, the result of the XQuery may be assigned to a parameter XQResultSequence result (202). The use of this interface is shown in the following section of code of the example of FIG. 3, wherein data from the retrieved XML document “Account” may be parsed and assigned to various variables (steps 203), which may then be displayed in 204.

FIG. 4, finally, presents an example how documents of the XML database can be handled by a dynamic application programming interface of the SDO handler if the complete structure of the response from the XML database is not known at development time. Whereas 301 and 302 are identical to the steps 201 and 203, the result of the XQuery may be, in this case, assigned to a dynamic DataObject. In order to extract the information contained within the DataObject, it may be parsed in 303 using, for example, the known methods defined in the SDO DataObject interface. Then the data contained in the retrieved XML document may be assigned to variables. However, due to the dynamic nature of this API of the SDO handler, it may not be necessary to predefine the structure of the DataObject into which the retrieved XML document may be converted during runtime. Usually it can be assumed that a user of a dynamic interface knows the content respectively the structure of the requested XML document.

Whereas the examples of FIGS. 3 and 4 are directed to the retrieval of XML documents, the described method and the SDO handler can, in a very similar manner, also be used for the opposite process, namely to convert a DataObject provided by the client application 1 into a XML document, which is then stored in the XML Database 100.

The described method can be implemented as an add-on software to either a standard client application and/or a database management system, which may be used to manage the XML database. The high degree of flexibility achieved by transforming the XML documents in service data objects is particularly useful if the XML database system is part of a service oriented architecture (SOA).

Although the embodiments above have been described in considerable detail, numerous variations and modifications will become apparent to those skilled in the art once the above disclosure is fully appreciated. It is intended that the following claims be interpreted to embrace all such variations and modifications.

1. A method of performing an operation on an XML database, the method comprising:
exchanging at least one DataObject between a client application and a Service Data Object (SDO) handler;
transforming the at least one DataObject into an XQuery operation for accessing XML documents of the XML database;
transforming an XML document obtained from the XML database in response to the XQuery into a resulting DataObject; and
storing the resulting DataObject.

2. The method of claim 1, wherein the client application is Java based and wherein the SDO handler provides an interface between DataObjects defined in Java and XQuery expressions.

3. The method of claim 2, wherein the interface provided by the SDO handler is a static interface which defines, at development time, the type of DataObject handled by the SDO handler.

4. The method of claim 2, wherein the interface is based on a schema definition of the XML documents stored in the XML database.

5. The method of claim 4, wherein the schema definition of the XML documents stored in the XML database is provided by a registry.

6. The method of claim 2, wherein the interface is a dynamic interface which defines at runtime the type of DataObject handled by the SDO handler.

7. The method of claim 1, wherein the operation on the XML database comprises at least one of:
Create, Read, Update, or Delete operations on the XML data in the XML database.

8. The method of claim 1, wherein the at least one DataObject comprises a collection of tree-structured data.

9. The method of claim 1, wherein the SDO handler is part of a XQuery API for Java.

10. A computer accessible memory medium storing program instructions for performing an operation on an XML database, wherein the program instructions are executable to:
exchange at least one DataObject between a client application and a Service Data Object (SDO) handler;
transform the at least one DataObject into an XQuery operation for accessing XML documents of the XML database; and
transform an XML document obtained from the XML database in response to the XQuery into a resulting DataObject.

11. The memory medium of claim 10, wherein the client application is Java based and wherein the SDO handler provides an interface between DataObjects defined in Java and XQuery expressions.

12. The memory medium of claim 11, wherein the interface provided by the SDO handler is a static interface which defines, at development time, the type of DataObject handled by the SDO handler.

13. The memory medium of claim 11, wherein the interface is based on a schema definition of the XML documents stored in the XML database.

14. The memory medium of claim 13, wherein the schema definition of the XML documents stored in the XML database is provided by a registry.

15. The memory medium of claim 11, wherein the interface is a dynamic interface which defines at runtime the type of DataObject handled by the SDO handler.

16. The memory medium of claim 10, wherein the operation on the XML database comprises at least one of:
Create, Read, Update, or Delete operations on the XML data in the XML database.

17. The The memory medium of claim 10, wherein the at least one DataObject comprises a collection of tree-structured data.

18. The memory medium of claim 10, wherein the SDO handler is part of a XQuery API for Java.

19. A system, comprising:
a processor; and
a memory medium coupled to the processor, wherein the memory medium stores program instructions for performing an operation on an XML database, wherein the program instructions are executable by the processor to:
exchange at least one DataObject between a client application and a Service Data Object (SDO) handler;
transform the at least one DataObject into an XQuery operation for accessing XML documents of the XML database; and
transform an XML document obtained from the XML database in response to the XQuery into a resulting DataObject.

20. The system of claim 19, wherein the client application is Java based and wherein the SDO handler provides an interface between DataObjects defined in Java and XQuery expressions.
